(19) United States
(12) Patent Application Publication
(10) Pub. No.: US 2026/0221358 A1
(43) Pub. Date: Jul. 30, 2026

(54) ELECTRIC SWITCH AND ELECTRIC SWITCH ASSEMBLY

(71) Applicant: ABB Schweiz AG, Baden (CH)

(72) Inventors: Jarmo Lehtimäki, Vaasa (FI); Markus Mäki, Seinäjoki (FI)

(21) Appl. No.: 19/451,612

(22) Filed: Jan. 16, 2026

(30) Foreign Application Priority Data
Jan. 27, 2025 (EP) 25154020.9

(51) Int. Cl. H01H 33/06; H01H 1/20; H01H 33/08; H01H 33/50; H01H 33/76

(52) U.S. Cl. CPC H01H 33/06; H01H 1/2058; H01H 33/08; H01H 33/50; H01H 33/76

(57) ABSTRACT

An electric switch includes a frame, a first stationary contact, a roll element rotatable relative to the frame, and a first movable contact. The roll element is rotatable relative to the frame about a first rotation axis between a first position and a second position. The first movable contact is rotatable relative to the frame about a second rotation axis between a first position and a second position, with the second rotation axis spaced from the first rotation axis. The switch further includes an actuator member that is fixed to the roll element and configured to move the first movable contact. The actuator member is arranged so that the rotation of the roll element causes movement of the first movable contact, with the first movable contact rotating through a greater angle than the roll element.

### CROSS-REFERENCE TO RELATED APPLICATIONS

This application claims priority to European Patent Application No. 25154020.9 filed on Jan. 27, 2025, and titled “ELECTRIC SWITCH AND ELECTRIC SWITCH ASSEMBLY”, the entire contents of which are hereby incorporated by reference.

### TECHNICAL FIELD

The present disclosure relates to an electric switch.

### BACKGROUND

An electric switch is a device adapted to open and close an electric circuit it is connected to. When an electric circuit is opened by an electric switch, an electric arc whose temperature is thousands of degrees may occur in the electric switch. An electric arc includes ionized gas, which contains a large number of free electrons. Such a gas plasma is electrically conductive.

An electric arc delays transfer of an electric switch from a conducting state to a non-conducting state. Further, an electric arc is often harmful for an electric switch and for an electric assembly comprising the electric switch.

A known method for enhancing the extinguishing of an electric arc in an electric switch is disclosed in document EP 3561839 A1 discussing a switching device having a roll element capable of rotating over 90° between positions corresponding to an ON-state and an OFF-state of an electric switch.

Another known method for enhancing the extinguishing of an electric arc in an electric switch is to use an arc shutter system. Examples of known electric switches provided with arc shutter systems are described in publications EP4376038A1 and EP3985700A1. The arc shutter systems described in said publications are especially efficient in electric switches in which a rotational angle of a rotating contact is relatively large, approximately 90° or larger.

### BRIEF DESCRIPTION

An object of the present disclosure is to provide an electric switch with an improved structure for efficiently extinguishing electric arcs.

The objects of the present disclosure are achieved by an electric switch described in the following.

The present disclosure is based on the idea of providing an electric switch in which a first movable contact is adapted to rotate around a different rotation axis than a roll element, wherein the roll element is a component adapted to be rotated by a control module or corresponding actuation mechanism. Owing to the spaced apart rotation axes of the first movable contact and the roll element, and an appropriate transmission mechanism between the roll element and the first movable contact, a rotation angle of the first movable contact is greater than a rotation angle of the roll element, thereby increasing a clearance angle between the first movable contact and corresponding stationary contact in an OFF-state of the electric switch.

An advantage of the electric switch of the present disclosure is that the clearance angle between the first movable contact and corresponding stationary contact can be increased without increasing the rotation angle of the roll element.

### BRIEF DESCRIPTION OF DRAWINGS

In the following, the present disclosure will be described in greater detail by some embodiments with reference to the attached drawings.

FIG. 1 shows an electric switch assembly according to an embodiment of the present disclosure.

FIG. 2 shows an exploded view of an electric switch of the electric switch assembly shown in FIG. 1.

FIG. 3a shows an operating mechanism of the electric switch of FIG. 2 in an ON-state of the electric switch.

FIG. 3b shows the operating mechanism of the electric switch of FIG. 2 in an OFF-state of the electric switch.

FIG. 4a shows a cross-sectional view of the operating mechanism of FIG. 3a.

FIG. 4b shows a cross-sectional view of the operating mechanism of FIG. 3b.

FIGS. 5a to 5e show side views of the operating mechanism of the electric switch of FIG. 2 in different states of the electric switch.

FIG. 6 shows an exploded view of an electric switch according to another embodiment of the present disclosure.

FIGS. 7a to 7c show cross-sectional side views of the electric switch of FIG. 6 in different states of the electric switch.

### DETAILED DESCRIPTION

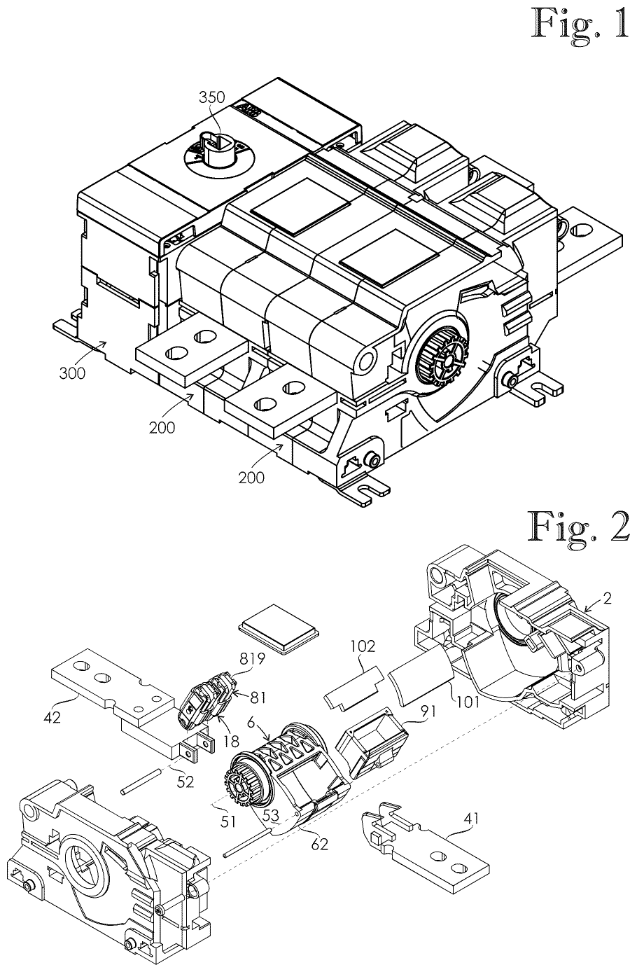

FIG. 1 shows an electric switch assembly comprising a control module 300 and two electric switches 200 operationally connected to the control module 300. The control module 300 is adapted to control the electric switches 200. The control module 300 comprises a control shaft 350 adapted to be manually rotated.

FIG. 2 shows an exploded view of the electric switch 200. The electric switch 200 comprises a frame 2, a first stationary contact 41, a second stationary contact 42, a roll element 6, a first movable contact 18, an actuator member 62 and an arc shutter system.

The first stationary contact 41 is stationarily fixed to the frame 2, and adapted to be connected to a power supply. The second stationary contact 42 is stationarily fixed to the frame 2, and adapted to be connected to a load.

The roll element 6 is rotatable relative to the frame 2 around a first rotation axis 51 between a first position and a second position. The actuator member 62 is stationarily fixed to the roll element 6. The actuator member 62 is made of electrically insulating material.

The first movable contact 18 is rotatable relative to the frame 2 around a second rotation axis 52 between a first position and a second position. The second rotation axis 52 is spaced apart from the first rotation axis 51. The first rotation axis 51 is parallel to the second rotation axis 52.

The first movable contact 18 is adapted to receive its driving force from the actuator member 62. The first movable contact 18 is adapted to be moved by the actuator member 62 such that movement of the actuator member 62 from the first position to the second position moves the first movable contact 18 from the first position to the second position.

The first movable contact 18 comprises a first contact portion 81 which in the first position of the first movable contact 18 is electrically conductively connected to the first stationary contact 41. In the second position of the first movable contact 18, the first movable contact 18 is disconnected from the first stationary contact 41.

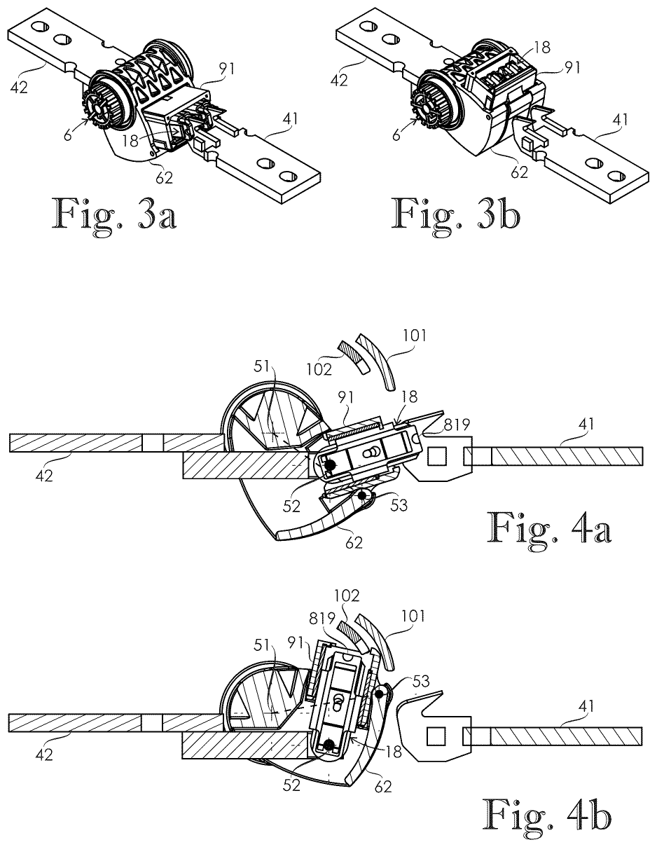

FIG. 3a shows an operating mechanism of the electric switch 200 in an ON-state of the electric switch in which the first contact portion 81 of the first movable contact 18 is electrically conductively connected to the first stationary contact 41. FIG. 3b shows the operating mechanism of the electric switch 200 in an OFF-state of the electric switch in which the first movable contact 18 is disconnected from the first stationary contact 41.

FIG. 4a shows a cross-sectional view of the operating mechanism of the electric switch 200 in the ON-state. FIG. 4b shows a cross-sectional view of the operating mechanism of the electric switch 200 in the OFF-state.

The second stationary contact 42 is electrically conductively connected to the first movable contact 18. Therefore, the electric switch 200 comprises a single contact gap.

The actuator member 62 is adapted to move the first movable contact 18 such that a rotation angle between the first position and the second position of the first movable contact 18 is greater than a rotation angle between the first position and the second position of the roll element 6. This operation is achieved by appropriately choosing a location of a contact point for the driving force transmitted from the actuator member 62 to the first movable contact 18. For example, FIG. 4a shows that a distance between the contact point for the driving force transmitted from the actuator member 62 to the first movable contact 18 and the first rotation axis 51 is greater than a distance between the contact point and the second rotation axis 52. The rotation direction of the first movable contact 18 is the same as the rotation direction of the actuator member 62.

In the electric switch 200, a rotation angle between the first position and the second position of the roll element 6 is 45°, and a rotation angle between the first position and the second position of the first movable contact 18 is 61°. In an alternative embodiment, a rotation angle between the first position and the second position of the first movable contact is greater than or equal to 120% of a rotation angle between the first position and the second position of the roll element. In a further alternative embodiment, a rotation angle between the first position and the second position of the roll element is less than or equal to 60°.

The arc shutter system is adapted to enhance extinguishing of an electric arc between the first stationary contact 41 and the first contact portion 81 of the first movable contact 18 during an opening event of the electric switch 200. The arc shutter system comprises a first arc shutter 91, a first counterpart member 101, and a second counterpart member 102. In an alternative embodiment, the arc shutter system comprises at least one counterpart member. In another alternative embodiment, the arc shutter system does not comprise any counterpart members.

It should be noted that adjacent to the second rotation axis 52, the actuator member 62 is adapted to participate in extinguishing of the electric arc by blocking the shortest route for the electric arc. In an alternative embodiment of the present disclosure, the electric switch does not comprise a first arc shutter movable relative to the roll element, wherein adjacent to the second rotation axis, only the actuator member is adapted for lengthening the electric arc.

The first arc shutter 91 is rotatable relative to the roll element 6 between a first position and second position around a third rotation axis 53. The first arc shutter 91 is made of electrically insulating material.

The third rotation axis 53 is spaced apart from the first rotation axis 51. A distance between the third rotation axis 53 and the first rotation axis 51 is greater than a distance between the second rotation axis 52 and the first rotation axis 51. The third rotation axis 53 is spaced apart from the second rotation axis 52 in all positions of the first arc shutter 91. The third rotation axis 53 is parallel to the first rotation axis 51.

The first arc shutter 91 surrounds a section of the first contact portion 81 such that on a plane perpendicular to a longitudinal direction of the first movable contact 18, a projection of the first contact portion 81 is inside a projection of the first arc shutter 91. The longitudinal direction of the first movable contact 18 extends between the second rotation axis 52 and a free end 819 of the first contact portion 81. On the plane perpendicular to the longitudinal direction of the first movable contact 18, a cross-section of the first arc shutter 91 has a form of a quadrilateral such that the quadrilateral completely surrounds a cross-section of the first contact portion 81.

In an alternative embodiment, the first arc shutter is movable relative to the roll element between a first position and a second position such that the movement of the first arc shutter relative to the roll element comprises other type of motion than rotation.

The first counterpart member 101 and the second counterpart member 102 are stationary relative to the frame 2. Each of the first counterpart member 101 and the second counterpart member 102 is adapted to cooperate with the first arc shutter 91 in order to enhance extinguishing of the electric arc by squeezing the electric arc between the first arc shutter 91 and the counterpart member.

In the second position of the roll element 6, there is a first narrowing section between the first arc shutter 91 and the first counterpart member 101, and a second narrowing section between the first arc shutter 91 and the second counterpart member 102. During the opening event, a route for the electric arc passes through the first narrowing section and second narrowing section. At the first narrowing section, the electric arc is forced to flow close to the first arc shutter 91 and the first counterpart member 101. At the second narrowing section, the electric arc is forced to flow close to the first arc shutter 91 and the second counterpart member 102. The first narrowing section and second narrowing section are best seen in FIG. 4b.

In an embodiment, in the first narrowing section, a distance between the first arc shutter and the first counterpart member is less than or equal to 1.5 mm.

The arc shutter system comprises extinguishing material adapted to evaporate during the opening event due to the electric arc, wherein the evaporated extinguishing material is adapted to enhance extinguishing of the electric arc. Examples of the extinguishing material comprise nylon 66 (PA 66 ), polyoxymethylene (POM), polymethyl methacrylate (PMMA) and polytetrafluoroethylene (PTFE).

In an embodiment, at least one counterpart member comprises the extinguishing material. In another embodiment, the first arc shutter comprises the extinguishing material.

A driving force for moving the first movable contact 18 is adapted to be transmitted from the actuator member 62 to the first movable contact 18 through the first arc shutter 91. In an alternative embodiment, the actuator member is adapted to move the first movable contact by means of a direct contact between the actuator member and the first movable contact.

When the actuator member 62 rotates relative to the frame 2, the actuator member 62 is in contact with the first arc shutter 91 such that the first arc shutter 91 moves with the actuator member 62. At the same time, the first arc shutter 91 is in contact with the first movable contact 18 such that the first movable contact 18 moves with the first arc shutter 91.

The first arc shutter 91 is adapted to move in an outward direction during the opening event, wherein the outward direction is directed from the second rotation axis 52 towards the free end 819 of the first contact portion 81. The first arc shutter 91 is adapted to move rectilinearly relative to first movable contact 18 during the opening event.

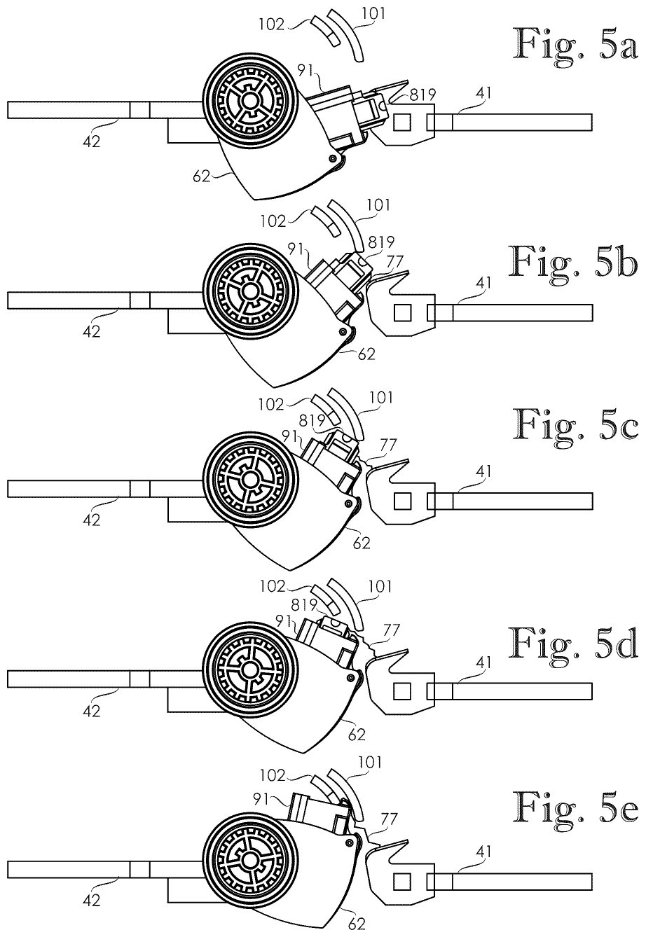

In the second position of the roll element 6, an outermost portion of the first arc shutter 91 is located further from the second rotation axis 52 than the free end 819 of the first contact portion 81 such that the first arc shutter 91 forces the electric arc to circumvent the outermost portion of the first arc shutter 91, thereby lengthening the electric arc. This effect is best seen in FIGS. 4b and 5e which show that the electric arc is forced to leave the first contact portion 81 from the free end 819 in the outward direction and to go around the outermost portion of the first arc shutter 91 before the electric arc is able to turn towards the closest point on the first stationary contact 41. As shown in FIG. 4b, without the actuator member 62 and the first arc shutter 91, a shortest route for the electric arc in the second position of the first movable contact 18 would be approximately half compared to the route forced by the actuator member 62 and the first arc shutter 91.

FIGS. 5a to 5e depict in detail the opening event of the electric switch 200 by showing side views of the operating mechanism of the electric switch 200 in different states of the electric switch. In FIG. 5a, the operating mechanism is in the ON-state. In FIG. 5e, the operating mechanism is in the OFF-state. In FIGS. 5b to 5d, the operating mechanism is in different intermediate states between the ON-state and the OFF-state. In FIGS. 5b to 5e, an electric arc between the first stationary contact 41 and the first contact portion of the first movable contact 18 is denoted with a reference number 77.

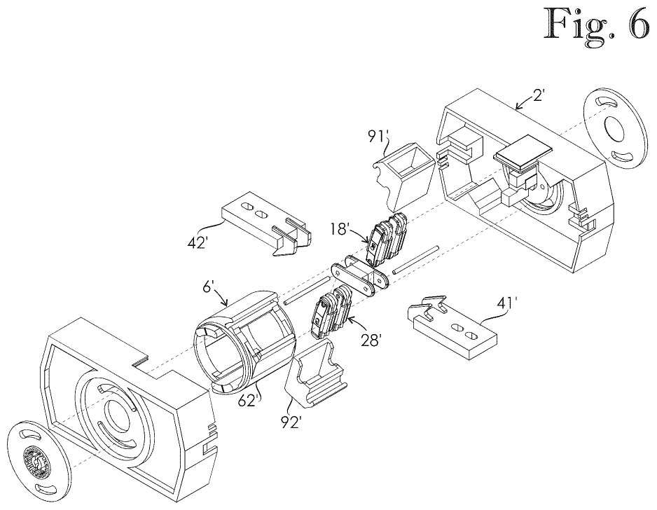

FIG. 6 shows an exploded view of an electric switch 200′ according to another embodiment of the present disclosure. The electric switch 200′ comprises a frame 2′, a first stationary contact 41′, a second stationary contact 42′, a roll element 6′, a first movable contact 18′, a second movable contact 28′, an actuator member 62′ and an arc shutter system.

The first stationary contact 41′ is stationarily fixed to the frame 2′, and adapted to be connected to a power supply. The second stationary contact 42′ is stationarily fixed to the frame 2′, and adapted to be connected to a load.

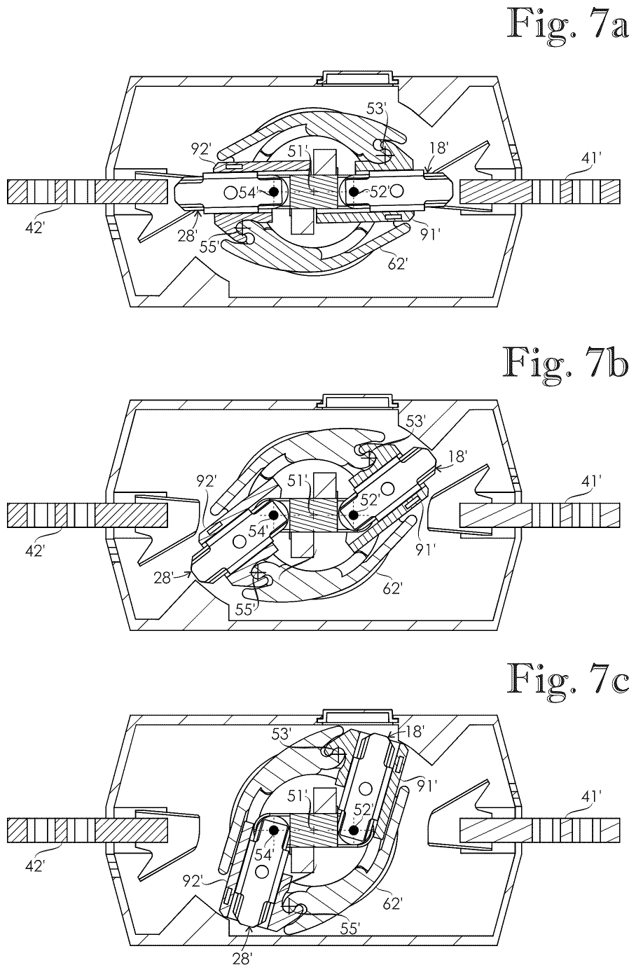

FIGS. 7a to 7c show cross-sectional side views of the electric switch 200′ in different states of the electric switch. In FIG. 7a, the operating mechanism is in the ON-state. In FIG. 7c, the operating mechanism is in the OFF-state. In FIG. 7b, the operating mechanism is in an intermediate state between the ON-state and the OFF-state.

The roll element 6′ is rotatable relative to the frame 2′ around a first rotation axis 51′ between a first position and a second position.

The first movable contact 18′ is rotatable relative to the frame 2′ around a second rotation axis 52′ between a first position and a second position. The second rotation axis 52′ is spaced apart from the first rotation axis 51′.

The first movable contact 18′ comprises a first contact portion which in the first position of the first movable contact 18′ is electrically conductively connected to the first stationary contact 41′. In the second position of the first movable contact 18′, the first movable contact 18′ is disconnected from the first stationary contact 41′.

The second movable contact 28′ is rotatable relative to the frame 2′ around a fourth rotation axis 54′ between a first position and a second position. The fourth rotation axis 54′ is spaced apart from the first rotation axis 51′ and from the second rotation axis 52′.

The second movable contact 28′ comprises a first contact portion which in the first position of the second movable contact 28′ is electrically conductively connected to the second stationary contact 42′. In the second position of the second movable contact 28′, the second movable contact 28′ is disconnected from the second stationary contact 42′.

The first movable contact 18′ and the second movable contact 28′ are adapted to receive their driving force from the actuator member 62′. The first movable contact 18′ and the second movable contact 28′ are adapted to be moved by the actuator member 62′ such that movement of the actuator member 62′ from the first position to the second position moves the first movable contact 18′ and the second movable contact 28′ from the first position to the second position.

The second movable contact 28′ is electrically conductively connected to the first movable contact 18′. The electric switch 200′ comprises two contact gaps.

FIG. 7a shows the operating mechanism of the electric switch 200 in the ON-state of the electric switch in which the first movable contact 18′ is electrically conductively connected to the first stationary contact 41′ and the second movable contact 28′ is electrically conductively connected to the second stationary contact 42′. FIG. 7c shows the operating mechanism of the electric switch 200′ in the OFF-state of the electric switch in which the first movable contact 18′ is disconnected from the first stationary contact 41′ and the second movable contact 28′ is disconnected from the second stationary contact 42′.

The actuator member 62′ is stationarily fixed to the roll element 6′. The actuator member 62′ is made of electrically insulating material. The actuator member 62′ is adapted to move the first movable contact 18′ and the second movable contact 28′ such that a rotation angle between the first position and the second position of the first movable contact 18′ as well as a rotation angle between the first position and the second position of the second movable contact 28′ are greater than a rotation angle between the first position and the second position of the roll element 6′. The rotation directions of the first movable contact 18′ and the second movable contact 28′ are the same as the rotation direction of the actuator member 62′.

The arc shutter system is adapted to enhance extinguishing of electric arcs between the first stationary contact 41′ and the first movable contact 18′ and between the second stationary contact 42′ and the second movable contact 28′ during an opening event of the electric switch 200′. The arc shutter system comprises a first arc shutter 91′ for the first movable contact 18′ and a second arc shutter 92′ for the second movable contact 28′.

Basically, the operation of the first arc shutter 91′ and the second arc shutter 92′ is similar to the operation of the first arc shutter 91 discussed above. There are only small differences such as implementation of rotation of the arc shutters around the third rotation axes. In the electric switch 200, the rotation of the first arc shutter 91 around the third rotation axis 53 is implemented with a separate shaft extending in the actuator member 62 and the first arc shutter 91 and rotatably connecting them. In the electric switch 200′, the rotation of the first arc shutter 91′ around the third rotation axis 53′ is implemented with a protrusion provided in the first arc shutter 91′ and a recess provided in the actuator member 62′ such that the recess and the protrusion are adapted to cooperate for providing the rotation of the first arc shutter 91′ relative to the actuator member 62′. The operation of the second arc shutter 92′ is identical to the operation of the the first arc shutter 91′.

In an embodiment, electric switch according to the present disclosure comprises at least one magnet and/or at least one extinguishing plate for enhancing the extinguishing of the electric arc. Such magnets and extinguishing plates are well known in the art, and therefore are not discussed in detail herein.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. An electric switch comprising:
a frame;
a first stationary contact stationarily fixed to the frame;
a roll element rotatable relative to the frame around a first rotation axis between a first position and a second position; and
a first movable contact rotatable relative to the frame around a second rotation axis between a first position and a second position,
wherein the first movable contact comprises a first contact portion which in the first position of the first movable contact is electrically conductively connected to the first stationary contact, and in the second position of the first movable contact the first movable contact is disconnected from the first stationary contact,
wherein the electric switch comprises an actuator member stationarily fixed to the roll element, wherein the actuator member is configured to move the first movable contact, wherein the second rotation axis is spaced apart from the first rotation axis and wherein the actuator member is configured to move the first movable contact such that a rotation angle between the first position and the second position of the first movable contact is greater than a rotation angle between the first position and the second position of the roll element.

2. The electric switch as claimed in claim 1, wherein the electric switch comprises an arc shutter system configured to enhance extinguishing of an electric arc between the first stationary contact and the first contact portion of the first movable contact during an opening event of the electric switch, and wherein the arc shutter system comprises a first arc shutter movable relative to the roll element between a first position and second position.

3. The electric switch as claimed in claim 2, wherein a driving force for moving the first movable contact is configured to be transmitted from the actuator member to the first movable contact through the first arc shutter.

4. The electric switch as claimed in claim 2, wherein the first arc shutter is configured to move in an outward direction during the opening event, and wherein the outward direction is directed towards a free end of the first contact portion.

5. The electric switch according to claim 4, wherein the first arc shutter is configured to move rectilinearly relative to first movable contact during the opening event.

6. The electric switch as claimed in claim 2, wherein the arc shutter system comprises at least one counterpart member configured to cooperate with the first arc shutter in order to enhance extinguishing of the electric arc by squeezing the electric arc between the first arc shutter and the at least one counterpart member.

7. The electric switch according to claim 6, wherein the at least one counterpart member is stationary relative to the frame.

8. The electric switch according to claim 6, wherein the at least one counterpart member comprises extinguishing material configured to evaporate during the opening event due to the electric arc, and wherein the evaporated extinguishing material is adapted to enhance extinguishing of the electric arc.

9. The electric switch as claimed in claim 3, wherein the first arc shutter is rotatable relative to the actuator member between the first position and second position around a third rotation axis, and wherein the third rotation axis is spaced apart from the first rotation axis.

10. The electric switch as claimed in claim 9, wherein a distance between the third rotation axis and the first rotation axis is greater than a distance between the second rotation axis and the first rotation axis.

11. The electric switch as claimed in claim 2, wherein the first arc shutter surrounds a section of the first contact portion such that on a plane perpendicular to a longitudinal direction of the first movable contact, a projection of the first contact portion is inside a projection of the first arc shutter.

12. The electric switch as claimed in claim 2, wherein in the second position of the roll element, an outermost portion of the first arc shutter is located further from the second rotation axis than a free end of the first contact portion 81 such the first arc shutter is adapted to force the electric arc to circumvent the outermost portion of the first arc shutter, thereby lengthening the electric arc.

13. The electric switch as claimed in claim 1, wherein a rotation angle between the first position and the second position of the first movable contact is greater than or equal to 120% of a rotation angle between the first position and the second position of the roll element.

14. An electric switch assembly comprising a control module and at least one electric switch comprising:
a frame;
a first stationary contact stationarily fixed to the frame ;
a roll element rotatable relative to the frame around a first rotation axis between a first position and a second position; and
a first movable contact rotatable relative to the frame around a second rotation axis between a first position and a second position,
wherein the first movable contact comprises a first contact portion which in the first position of the first movable contact is electrically conductively connected to the first stationary contact, and in the second position of the first movable contact the first movable contact is disconnected from the first stationary contact,
wherein the electric switch comprises an actuator member stationarily fixed to the roll element, wherein the actuator member is configured to move the first movable contact, wherein the second rotation axis is spaced apart from the first rotation axis, and wherein the actuator member is configured to move the first movable contact such that a rotation angle between the first position and the second position of the first movable contact is greater than a rotation angle between the first position and the second position of the roll element.

15. The electric switch as claimed in claim 1, wherein the first rotation axis is parallel to the second rotation axis.

16. The electric switch as claimed in claim 3, wherein the first arc shutter is configured to move in an outward direction during the opening event, and wherein the outward direction is directed towards a free end of the first contact portion.

17. The electric switch as claimed in claim 3, wherein the arc shutter system comprises at least one counterpart member configured to cooperate with the first arc shutter in order to enhance extinguishing of the electric arc by squeezing the electric arc between the first arc shutter and the at least one counterpart member.

18. The electric switch as claimed in claim 4, wherein the arc shutter system comprises at least one counterpart member configured to cooperate with the first arc shutter in order to enhance extinguishing of the electric arc by squeezing the electric arc between the first arc shutter and the at least one counterpart member.

19. The electric switch as claimed in claim 5, wherein the arc shutter system comprises at least one counterpart member configured to cooperate with the first arc shutter in order to enhance extinguishing of the electric arc by squeezing the electric arc between the first arc shutter and the at least one counterpart member.

20. The electric switch according to claim 7, wherein the at least one counterpart member comprises extinguishing material configured to evaporate during the opening event due to the electric arc, and wherein the evaporated extinguishing material is adapted to enhance extinguishing of the electric arc.
